(19) United States
(12) Patent Application Publication
(10) Pub. No.: US 2019/0147396 A1
(43) Pub. Date: May 16, 2019

(54) PREDICTING SHELF LIFE BASED ON ITEM SPECIFIC METRICS

(71) Applicant: Walmart Apollo, LLC, Bentonville, AR (US)

(72) Inventors: Joshua Bohling, Centerton, AR (US); Terry Osbon, Fayetteville, AR (US); Craig Trudo, Centerton, AR (US); Riley Turben, Bentonville, AR (US); Brandon Elliot Johnsen, Rogers, AR (US)

(21) Appl. No.: 16/112,974

(22) Filed: Aug. 27, 2018

Related U.S. Application Data
(60) Provisional application No. 62/584,396, filed on Nov. 10, 2017.

(51) Int. Cl. G06Q 10/08; G06N 5/04

(52) U.S. Cl. CPC G06Q 10/087; G06N 5/04

(57) ABSTRACT

Examples of the disclosure provide for a freshness indicator and shelf life prediction system. Product-specific data is obtained for a product and an environment associated with the product from various information sources and sensors. The obtained product-specific data is used to calculate freshness indicator values for a given product. The calculated freshness indicator values are used to calculate a shelf life prediction for the given product.

### BACKGROUND

Product shelf life is one factor used in inventory management. Shelf life may vary from product to product based on a number of factors. Systems and methods that identify freshness for a perishable product, for example, may enable a better predictor of shelf life for fresh items.

### SUMMARY

Examples of the disclosure provide for a computing system for generating a freshness indictor value for produce, the computing system comprising at least one input device, a memory device storing computer-executable instructions, and a processor configured to execute the computer-executable instructions to receive pre-harvest produce specific parameter data associated with a produce at least once prior to harvesting of the produce via the at least one input device, compare the received pre-harvest produce specific parameter data with at least one pre-harvest produce threshold associated with the produce, and generate a first value of a freshness indicator associated with the produce based on the comparison at a freshness value generator.

Still other examples provide one or more computer storage devices storing computer-executable instructions for inspecting produce. The computer-executable instructions are executed by a computer to cause the computer to perform operations, including identifying produce and gathering information about the produce, obtaining data by a computing device regarding the produce; processing the data to determine freshness indicators and shelf life; and generating an alert responsive to the freshness of the produce.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary process diagram illustrating systems and methods for obtaining product data during a product life cycle for use in determining freshness and/or predicting shelf life for the product in accordance with the disclosure.

FIG. 2 is an exemplary computing device configured to perform embodiments of the systems and methods described herein in accordance with the disclosure.

FIG. 3 is an exemplary chart of one embodiment of an output of a shelf life predictor in accordance with the disclosure.

FIG. 4 is an exemplary block diagram illustrating a set of sensors for gathering environmental and produce data in accordance with the disclosure.

FIG. 5 is an exemplary flow chart of a process for determining freshness and predicting shelf life of produce in accordance with the disclosure.

FIG. 6 is an exemplary illustration of a device identifying freshness information about a piece of produce in accordance with the disclosure.

FIG. 7 is an exemplary embodiment of a computing environment for implementing processes and methods described herein in accordance with the disclosure.

Corresponding reference characters indicate corresponding parts throughout the drawings.

### DETAILED DESCRIPTION

Predicting shelf life of produce is a factor in selling produce to the public. Appropriately predicting shelf life prevents waste and minimizes the chances of customers dissatisfaction with the produce. Additionally, fresh produce often tastes better and provides a competitive advantage.

To predict shelf life, produce may be inspected throughout its life cycle, including during pre-harvesting, harvesting, and transport from growing/producing areas, distribution centers, and/or consumer markets. Products such as produce may be inspected, or product data collected, throughout acquisition, production, transportation, storage, and/or sales to identify current product characteristics. For example, produce may have or may acquire certain characteristics that are used to determine freshness and/or predict shelf life for that produce. In addition, environmental factors associated with a product, such as temperature, may also impact the products characteristics and/or life cycle. Environmental factors associated with a product may be identified, collected, tracked, and/or obtained to aid in freshness determinations and/or shelf life predictions.

Products, such as produce for example, must also meet certain regulation standards before they may be offered to the public. In addition to government regulations, many corporations and/or industries have their own standards. For instance, some companies may only want to provide produce grown or produced locally. The company may use such selectivity as a differentiating factor when comparing itself to its competitors.

Inspecting produce is often a time consuming, labor intensive, and technologically challenging endeavor. The logistics involved in gathering the relevant data, making the appropriate decisions based on the data, and implementing the decision pose a significant challenge for many corporations. Additionally, the regulations and standards may change periodically or with very little notice, and changes may only affect some produce and not others. Suppliers, distributors, and retailers are required to keep abreast of the changes. While human monitors may use certain types of equipment to assist, the overall process is manually labor intensive and prone to error.

Referring to the figures, examples of the disclosure enable systems and methods for monitoring and collecting product data throughout various stages of a product life cycle and using the product data to determine a freshness value for a product and/or to predict shelf life of a product, using item-specific criteria. In some examples, a freshness component is provided for automatic analysis of product data using specific criteria associated with the product by analyzing sensor data received from at least one of a set of sensors. Inspection data may also be obtained by the freshness component, including information about identified characteristics associated with an inspected product, in order to determine an updated freshness value or indicator for the product based on the inspection data.

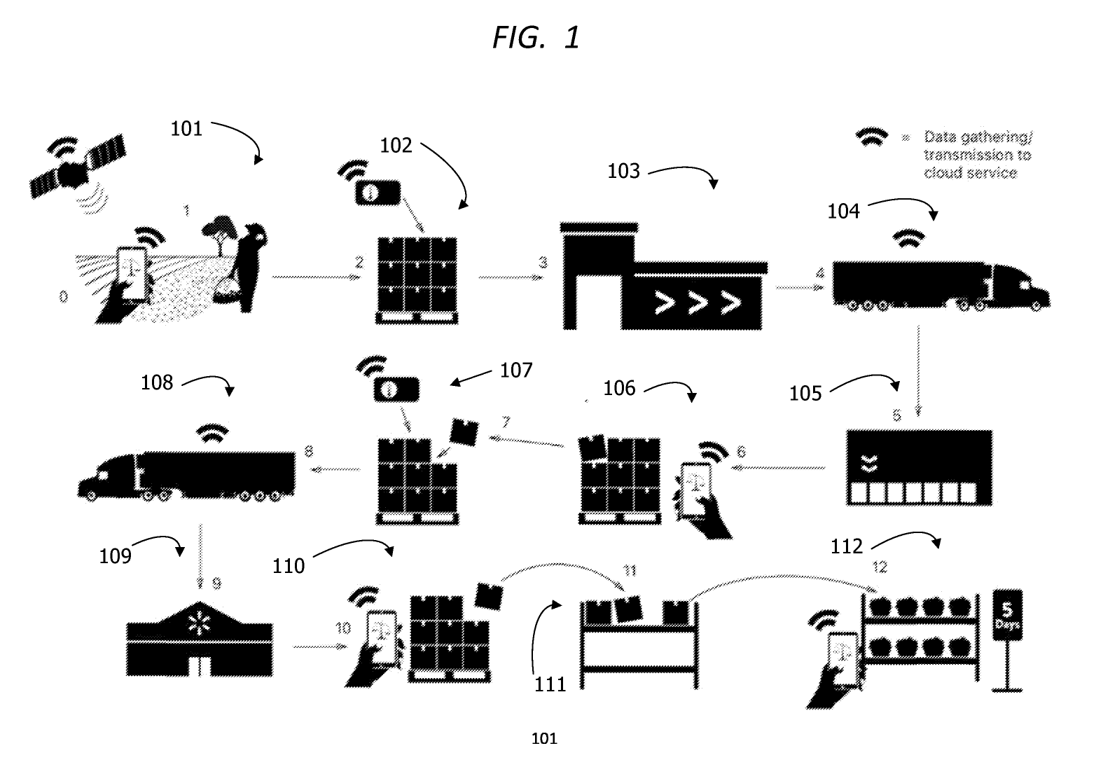

Referring to FIG. 1, an exemplary process diagram illustrates systems and methods for obtaining product data during a product life cycle for use in determining freshness and/or predicting shelf life for the product. In the examples herein, produce is used for illustrative purposes to describe a product life cycle and data capture and analysis for the product. The examples herein are not intended to limit aspects of this disclosure in any way, and it should be understood that products other than produce are within the scope of this disclosure.

During pre-harvest stage 101, pre-harvest product data may be obtained from various sources. Pre-harvest product data may include, without limitation, crop data, field data, growth rate data, geolocation data, quality metrics, environmental data, condition data, and the like, for example. Environmental data or condition data, may include information such as weather data for the geo-location associated with the pre-harvest product. In some examples, the environmental data may be obtained separately from other product data, and correlated with the product data based on geolocation and timestamp data, for example. The pre-harvest product data may be captured and/or collected, and transmitted and/or stored, incrementally or continuously throughout the pre-harvest stage and into the harvesting stage as well. The various sources may include grower databases, field and/or crop tracking technologies implemented by a grower, public sources, and/or observational data inputs. For example, growers may use a number of different sensors and systems implemented in their fields and/or growing areas to monitor and track crop and field data, which may be obtained by the systems described herein as pre-harvest data for the associated product. Growing areas may include greenhouses, fields, orchards, gardens, hothouses, barns, coops, pens, pastures, and/or any other suitable product development area. Public data, such as weather data, may be obtained by the system described herein for the geo-location associated with the product as data associated with the product.

In other examples, observers may survey a growing area, such as a field, for subjective data on a product and use a mobile computing device to input pre-harvest data points. For example, an observer may compare the automated crop projections, generated based on the other pre-harvest data or industry projections, against observed crop development to provide additional inputs that may be used adjust crop projections and/or harvest projections. One or more mobile applications implementing an inspection component may be used to record real-time data, including information about crop progress, geolocation, environmental factors, and quality/condition characteristics of the product. Other data may also be recorded depending on the circumstances. In some examples, a mobile application may be configured to obtain pre-harvest product-specific data associated with a particular product at least once prior to harvesting of the produce. For example, the particular product may be a crop of strawberries, and pre-harvest data for that particular crop of strawberries may be the associated product-specific data. In other words, the product-specific data associated with a product is for a specific batch, crop, or set of the product type. In these examples, the mobile application may provide the obtained pre-harvest product-specific data at a user interface for comparison and/or evaluation by an observer, in order to prompt user confirmation of actual conditions.

At harvest stage 102, produce may be packed into cases marked with lot numbers, or global location numbers, along with date and/or timestamps corresponding to the pack date, or harvest date, for the produce. Environmental factors associated with the produce, such as rain, dew point, temperature, and UV index for example, may be obtained by the system described herein from public sources, such as the National Oceanic and Atmospheric Association's (NOAA) weather network, and correlated to the pack date and lot numbers of the cases. The system may store the correlated lot numbers, pack date and environmental information as harvest product-specific data for that produce, for example. A sensor or probe may be activated and placed inside at least one case per pallet. The sensor may be a Wi-Fi-enabled temperature sensor in some examples. In other examples, one or more different types of sensors may be used, including without limitation, a temperature sensor, humidity sensor, pressure sensor, and/or any other suitable sensor for detection conditions associated with the packed produce. The system obtains condition data associated with the produce from the sensor or probe.

At transfer event 103, the pallets and/or cases of packed produce are transferred to a cooling and/or packing facility. The cooling and/or packing facility may be a grower facility or a third-party facility, in some examples. The sensor or probe from harvest event 102 remains with the cases and continues to collect environmental, temperature, and humidity data, including rate of cooling, which may be obtained by the system and used along with the pre-harvest and harvest product-specific data to calculate a set of freshness indicator values. It should be appreciated that the sensors or probes may detect and/or transmit other data such as pressure, air quality, and the like. The sensor data may be separately stored by the system as supply chain product-specific data. In some examples, a freshness indicator value may be calculated prior to receipt of a product at a packing facility, and an updated freshness indicator value or set of values may be calculated based on the sensor data acquired during a time period between harvest and arrival at a packing facility. The system may be configured to obtain supply chain product-specific data associated with the product during a time period extending from post-harvest through inspection of the product at a final touch point, and incrementally update freshness indicator values at set intervals or dynamically.

At transport event 104, the produce may be loaded onto a transport vehicle for transition from a packing facility to a distribution center. Each sensor, such as a temperature probe, associated with the cases of produce continues to detect and/or transmit data. In addition, one or more other sensors implemented within one or more cases, or implemented within a transportation vehicle associated with the cases of produce, may detect and/or transmit geolocation and environmental data. In some examples, product transportation vehicles may be equipped with on-board computing devices that provide geolocation, route, and associated environmental data. The path of travel corresponding to the transport vehicle may also be obtained for additional association with environmental factors. This data may be stored by the system as part of the supply chain product-specific data, for example. The supply chain product-specific data may include transportation data associated with the produce post-harvest.

At distribution center stage 105, the product arrives at a distribution center. The product may be inspected using an inspection system, such as an inspection system implemented on a mobile device with a mobile application for example. The inspection system may implement USDA and entity-specific or industry-specific specifications for inspection of a product type. At initial inspection stage 106, the inspection system generates inspection data, which the system obtains for use in determining updated freshness indicator values for the product. In some examples, the system may prompt the inspection system, or an inspector, to confirm quality and/or condition issues on the incoming lot based on the pre-harvest data, harvest data, supply chain data, and/or the initial generated freshness indicator value or set of values. The inspection system may assign the produce an inspection score by lot number, which is then associated to each case corresponding to that lot number. The freshness indicator system may then calculate updated freshness indicator values for the produce based at least in part on the inspection score.

In some examples, the inspection stage 106 occurs at a distribution center before transport to market. The freshness score assigned at this stage may be used by markets to prioritize placement of the product, and feedback from the markets on inspections performed at a final touchpoint of the product may be used by the system as feedback to refine freshness indicator models and shelf life prediction models. In some examples, training data may be generated for the system to train a machine learning component of the system to calculate freshness indicator values and shelf life predictions. The training data may be generated using a retention sampling application, in some examples. The retention sampling application may inspect a sample sub-set of a product as described for initial inspection stage 106, to generate a freshness score or freshness indicator value. The sample sub-set may then be maintained at the distribution center, in this example, at the preferred storage conditions and monitored by the system to identify data points of the products life cycle, such as a duration of time that the item remains at various freshness points, a duration of time at which the item reaches the end of shelf life, and the like. These data points obtained by the system from the retention sampling application may be used to refine models for freshness indicators, shelf life prediction, and obtain data points on optimal environmental conditions for shelf life extension, for example. The system may combine the data points obtained on optimal environmental conditions with real-time data associated with actual environmental factors corresponding to a product to calculate differentials used for adjusting calculations, for example.

At supply chain optimization stage 107, the system determines how to prioritize the movement of the produce case through the remaining supply chain. The original temperature sensor or probe may be removed from the pallet. A systemically chosen case or cases may be transferred to a new pallet for delivery to a designated market. A new sensor, such as a temperature probe or sensor, may be placed inside the new pallet for environmental monitoring on route to market. At transport event 108, the produce transferred to the new pallet is loaded onto a transport vehicle for transition to the market. Each sensor continues to detect and/or transmit data, which the system may use to update a freshness indicator value or set of values. In addition, geolocation and environmental data associated with the transport may be obtained by the system and used in determining an updated freshness indicator value as well.

At market event 109, the product arrives at the market. The sensors associated with the cases on the pallets that arrive at market may continue to detect and/or transmit data, which may be used to determine information, such as how long a pallet of product sits in ambient temperatures before moving to a cold storage, how long the product remains in cold storage and at what temperatures, when a product goes out onto the floor from cold storage, and so on, for example. At inspection event 110, the product is inspected upon market intake using the inspection system, which may be another instance of the inspection system at 106, such as a mobile application which combines USDA and entity-specific specifications to generate product-specific inspection criteria. The system may also prompt the inspection system, or an inspector, as to quality/condition issues on the incoming produce based on the obtained supply chain product-specific data. A new or updated freshness indicator value or score may be calculated. At prediction event 111, a shelf life predictor estimates the shelf life of the product based on the one or more calculated freshness scores. The system may then inform a market where in the picking/placement order the newly received product should be placed.

At placement event 112, the produce is picked from the back room of the market and placed on display. In some examples, a market associate may use a mobile application to make a final inspection of the product at this final touchpoint. This inspection data may be used to refine the system weighting of environmental factors, NOAA information, geolocation data, pre-harvest data, harvest data, supply chain data, and associated freshness indicator scores. The predicted shelf life may be displayed on signage for marketing or pricing purposes. In some examples, the signage may include a digital or electronic display, which may provide consumer-facing information about the product based on the data obtained by the system, the freshness indicator values calculated by the system, and the shelf life prediction generated by the system. For example, a product display may provide information about a product, such as a selection of strawberries, including the predicted shelf life for the selection, a duration of time since the selection was harvested, an origin of the selection, or any other desirable information identified by the system. Shelf life, as used herein, refers to a sell by date, or otherwise an indicator of how fresh a product may be relative to an expected life cycle for the product. The system described herein calculates freshness scores and predicts shelf life, which may be used in any number of produce related activities such as, without limitation, priority of placement of the produce in a store from an inventory of produce type associated with the produce, selection of a distribution center for the produce, pricing of the produce, inspection criteria for the produce; safety stock number of the produce at the store, shelf life of the produce, quality metrics associated with different suppliers of the produce type, and determining impact of weather on the quality of the produce type, for example.

In some examples, the freshness indicator values, or freshness scores, and/or the shelf life predictions generated for a product may be used for dynamic inventory management and optimization, dynamic supplier/distributer alignment, tiered valuation, proactive inspection criteria, flexible safety stock determinations, predictive cooler dwell inspections, increasingly effective supplier negotiations, and the like. Dynamic inventory management may be impacted by the outputs of the system described herein, such as by a “first expired first out” optimization model rather than a “first inventoried first out” model. Dynamic supplier/distributer alignment may be impacted by using the outputs of the system described herein to intelligently route product selections based on historical transit issues, route information, and the freshness score prioritization, such as by routing lower freshness scores to nearby distributers to reduce transportation time for example.

Tiered valuation may be accomplished using outputs of the system described herein, which may reduce throwaways and markdowns at the market. Proactive inspection criteria may be provided to the inspection system from the system described herein in order to enable insights for the inspection system to prompt particular inspection criteria for specific product selections. Flexible safety stock determinations may be made based on outputs of the system described herein to spin safety stock numbers up and down depending on observed weather patterns and initial freshness indicators, for example. Predictive cooler dwell inspections may use outputs of the system described herein, such as the freshness indicators, to predict and highlight days of life for at-risk product at distribution center coolers, for example. Comparative freshness indicator data for products obtained from different suppliers may provide insights and data points into quality of products originating from specific locations, the impact of weather events on quality and/or condition of products, and other gaps in the product life cycle that may impact shelf life, for example.

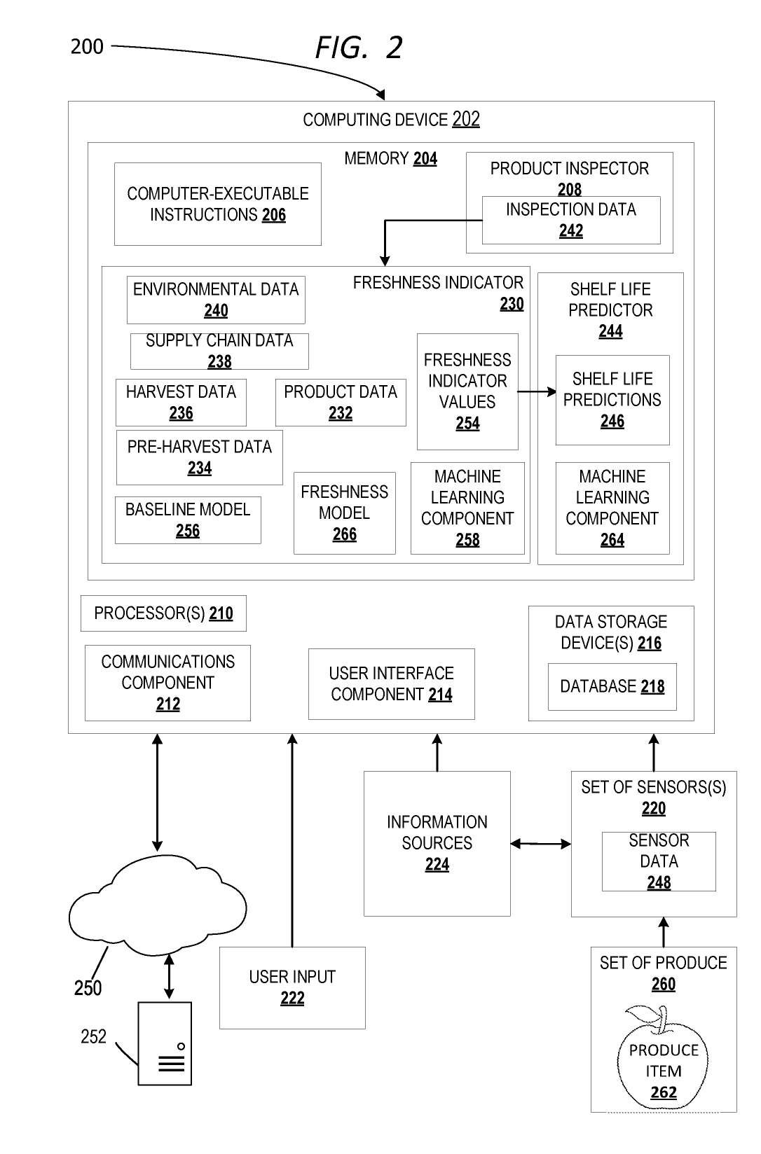

Referring to FIG. 2, an exemplary computing device configured to perform embodiments of the systems and methods is described. Computing device 202 is configured to perform embodiments of the systems and methods described herein. The computing device 202 communicates with information sources 224 and a set of sensors 220 to obtain data associated with produce item 262 and/or a set of produces 260.

The computing device 202 represents any device executing instructions (e.g., as application programs, operating system functionality, or both) to implement the operations and functionality associated with the computing device 202. In some examples, computing device 202 may be a cloud-based device implemented across one or more processors, such as processor(s) 210. In other examples, the computing device 202 may represent a group of processing units or other computing devices.

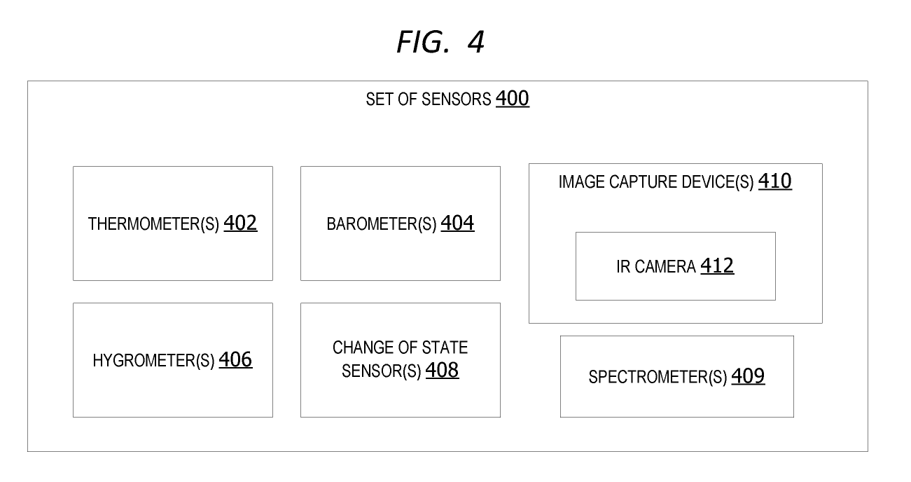

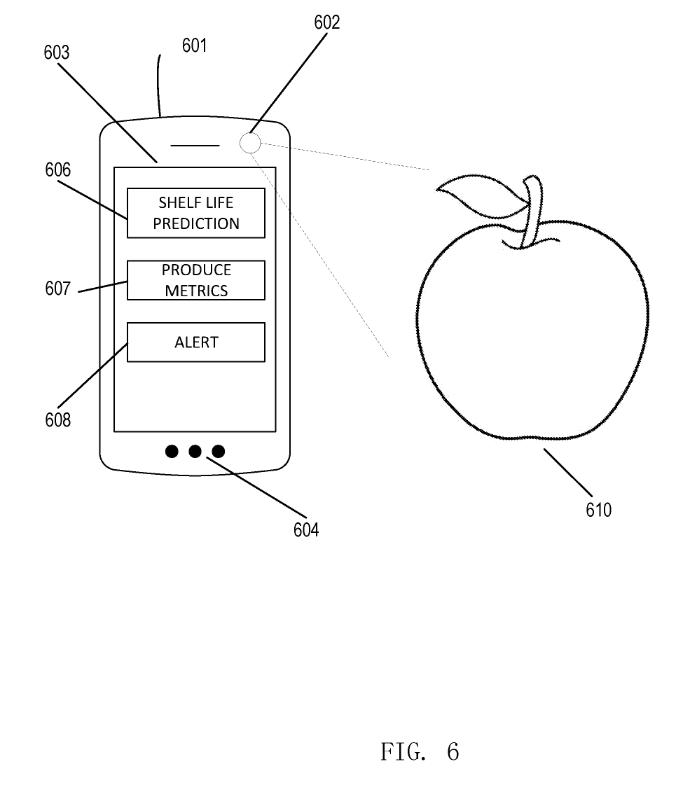

In some examples, the computing device 202 includes one or more processor(s) 210, a memory 204, a communications component 212, and a user interface component 214. The one or more processor(s) include any quantity of processing units. At least one processor of the one or more processors(s) 210 is programmed to execute computer-executable instructions 206 for implementing the examples herein. The computer-executable instructions 206 may be performed by the processor or by multiple processors within the computing device 202, or performed by a processor external to the computing device 202. In some examples, the processor is programmed to execute instructions such as those illustrated in the figures (e.g., FIG. 4 and FIG. 6).

In some examples, the one or more processor(s) represent an implementation of analog techniques to perform the operations described herein. For example, the operations may be performed by an analog computing device and/or a digital computing device.

The computing device 202 may include one or more computer readable media such as the memory 204. The memory 204 includes any quantity of media associated with or accessible by the computing device 202. The memory 204 may be internal to the computing device (as shown in FIG. 2), external to the computing device (e.g. external server 252), or both. In some examples, the memory 204 includes read-only memory and/or memory wired into an analog computing device.

The memory 204 stores data, such as one or more applications. The applications, when executed by the processor, operate to perform functionality on the computing device. The applications may communicate with counterpart applications or services such as web services accessible via a network. For example, the applications may represent downloaded client-side applications that correspond to server-side services executing in a cloud. Exemplary applications may include product inspector 208, freshness indicator 230 and shelf life predictor 244.

The memory 204 may include one or more computer-executable components. Exemplary components include communications component 212 and user interface component 214. In other examples, the memory 204 includes an analysis engine, sensor data, image capture data, and/or processed sensor data.

In some examples, the product inspector 208, when executed by the processor of the computing device 202, causes the processor to obtain product-specific data corresponding to a product for inspection, such as sensor data from sensors associated with an inspection system, process the obtained product-specific data to identify a type of product, such as a type of produce for example, and determine whether the identified product meets inspection criteria thresholds. Product inspector 208 may further comprise product data used to identify products and product types being inspected, regulatory requirements, industry requirements, and/or any other entity-specific criteria for inspection. In some instances, product data may be stored in database 218 or external server 252, and retrieved by product inspector 208. Product inspector 208 generates product-specific inspection data 242 for each product or set of products that is inspected.

Although product inspector 208 is depicted as implemented on computing device 202 for illustrative purposes, it should be understood that product inspector 208 may be implemented remotely from computing device 202 in some examples, such as on a remote computing device that is local to set of produce 260 or other products being inspected, for example. When implemented remote from computing device 202, product inspector 208 may communicate with computing device 202 via network 250, for example.

The set of sensors 220 is a set of one or more sensors associated with set of produce 260 or an environment corresponding to the set of produce 260. The set of sensors may include one or more types of sensors, such as, without limitation, temperature sensors, image capture devices, hygrometers, barometers, motion sensors, spectrometers, proximity sensors, or any other type of sensor. An image capture device may include an analog camera, a digital camera, an IR camera, or other type of camera. The set of sensors 220 may include one or more sensors integrated within the computing device 202 in some examples. In other examples, the set of sensors 220 includes one or more sensors exterior to the computing device 202. The product inspector 208 and freshness indicator 230 may obtain sensor data from the set of sensors 220, for example.

Although product inspector 208, freshness indicator 220, and shelf life predictor 244 are depicted as integrated with computing device 202 for illustrative purposes, these applications may be separately implemented on different computing devices, remote from computing device 202, in some examples. In other examples, product inspector 208 may be separately implemented on a remote computing device relative to computing device 202, as part of an inspection system, and communicatively coupled to computing device 202 having freshness indicator 220 and shelf life predictor 244.

Computing device 202, in some examples, communicates with external devices, cloud infrastructure, and networks via communications component 212. External server 252 and computing device 202 are communicatively coupled to network 250. Networks may include, without limitation, a local area network (LAN), such as an Ethernet connection, or a wide area network (WAN), such as the Internet. Networks may be a wired network or a wireless network, such as WI-FI. In other examples, the product inspector 208 requests sensor data from the set of sensors 220 via the network 250. The set of sensors may transmit sensor data via the network in response to a request from an inspection system, such as product inspector 208. In other examples, the set of sensors automatically transmits sensor data to the product inspector 208 in real time as the sensor data is generated. In still other examples, the sensor data is sent to computing device 202 at regular intervals or in response to a predetermined event.

Communications component 212 may include a network interface card and/or computer-executable instructions (e.g., a driver) for operating the network interface card. Communication between the computing device and other devices may occur using any protocol or mechanism over any wired or wireless connection. In some examples, the communications interface is operable with short range communication technologies such as by using near-field communication (NFC) tags.

Product inspector 208 may generate an alert or notification if the sensor data obtained indicates a product does not meet one or more of a set of rules or inspection criteria. For example, one rule for an item may be the absence of any puncture or hole. Another rule may be a certain threshold percentage of defects permitted over the surface of a produce. In some examples, if product inspector analysis of the sensor data indicates the identified defects of a produce exceeds the rule (higher or lower than the threshold), an alert is generated and output via the user interface component 214.

In some examples, an alert is generated and output to one or more user interfaces via user interface component 214. A user interface may be a screen that displays the alert to a user or a speaker that generates an audible sound which the user can hear. Other user interfaces are also possible. Examples of other interfaces are command line prompts, graphical user interfaces, augmented reality, tactile and feedback interfaces, digital menus, and the like. User interface component 214 may output generated alerts to user interface displays of remote computing systems communicatively coupled to computing device 202, in some examples, such as a remote handheld device (not shown) communicatively coupled to computing device 202 via network 250, for example.

Data storage devices(s) 216 may include one or more databases, such as database 218. Database 218 may store information regarding products and product types, such as information about produce and produce types, which may be used by the product inspector 208 to identify produce item 262 and/or set of produce 260 from the obtained sensor data 248.

In other examples, the data storage may also be implemented externally to mobile computing device 202 such as in external server 252 and accessed via network 250. The data storage device(s) may include rotational storage, such as a disk. The data storage device(s) may also include non-rotational storage media, such as a solid-state drive (SSD) or flash memory. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device.

The set of sensors 220 may include one or more sensors implemented in various locations and throughout various stages of the produce life cycle. For example, one or more sensors from the set of sensors 220 may obtain environmental data associated with the set of produce 260. The set of sensors 220 may include one or more sensors for detecting characteristics of the produce and/or the environment within and/or around the produce. In this example, the set of sensors 220 incudes at least one temperature probe (not shown). The temperature probe may record temperature of the produce or environmental temperature associated with the produce. In other examples, the set of sensors 220 may include one or more sensors implemented in a growing area, such as a field, to detect growth conditions, one or more sensors implemented in cases of post-harvest produce to detect environmental conditions associated with the produce post-harvest and/or characteristics of the produce post-harvest, one or more sensors implemented in a transport vehicle to detect environmental conditions associated with transport of the produce, one or more sensors implemented in a facility, such as a packing facility, cooling facility, distribution center, or market, to detect environmental conditions associated with the produce during its duration at each facility, and so on. Any number of sensors, and any number of different types of sensors, may be contemplated by aspects of this disclosure for detecting and/or transmitting sensor data of products and environmental conditions associated with the products.

The set of sensors 220 may transmit and/or provide sensor data 248 to computing system 202, and in particular directly to one or more of product inspector 208 or freshness indicator 230, in some examples. In other examples, set of sensors 220 may transmit sensor data 248 to a storage device, such as data storage devices 218, external server 252, or another storage device configured to be accessed by computing device 202. In some examples, one or more sensors in set of sensors 220 may have integrated storage for local storage of sensor data until the sensor data is transmitted and/or obtained by a computing device. In some examples, sensor data 248 may include pre-harvest data 234, harvest data 236, supply chain data 238, and environmental data 240, which may be obtained by freshness indicator 230. In other examples, sensor data 248 may be obtained by and/or stored at one or more information sources 224, which may generate pre-harvest data 234, harvest data 236, supply chain data 238, and environmental data 240. In these examples, freshness indicator 230 may obtain pre-harvest data 234, harvest data 236, supply chain data 238, and environmental data 240 from information sources 224. In yet other examples, a hybrid approach may be contemplated where pre-harvest data 234, harvest data 236, supply chain data 238, and environmental data 240 are generated by freshness indicator 230 based in part on obtained sensor data 248 and based in part on obtained data from information sources 224. For example, sensor data 248 may indicate product characteristics for a crop pre-harvest, which may be combined with obtained weather data for the geolocation associated with the crop from information sources 224, and used to generate pre-harvest data 234 for that crop of product.

Information sources 224 may include, without limitation, sensors, such as set of sensors 220, public sources, such as NOAA application programming interfaces (APIs) and other public information sources, transport vehicle on-board computing systems, third-party TMS APIs, crop data technology APIs, field data technology APIs, grower data technology APIs, inspection system APIs, market applications, and/or any other suitable information source associated with a product or product environment. Freshness indicator 230 may obtain input from information sources 224 via APIs and assign each data input a weight in freshness model 266 when calculating against a baseline model 256, which may be “best case” or “ideal” scenario for a given product. In other words, baseline model 256 provides optimal freshness indicator values for a given product based on ideal growth, harvest, transport, packing, storage, and inspection conditions, which freshness indicator 230 calculates actual obtained data points for the product against in freshness model 266 to determine the freshness indicator values for that product. Machine learning component 258 may obtain and/or receive market feedback on realized shelf life at market for the product and/or inspection feedback on realized freshness or other characteristics of the product that may be used as a feedback loop to refine freshness model 266.

The set of sensors may be part of the computing system in some examples, or used independently to gather data in other examples. Sensors may be implemented within part of storage facilities, used in the fields or where the produce is grown, or implemented within part of transportation vehicles. In some cases, sensors are implemented in part of the pallets that are used to transport the produce. The set of sensors may be one instrument implementing different sensors, or different instruments implementing discrete sensors. In some examples, the sensor data may include temperature data, timestamp data, barometer data, hygrometer data, change of state data, IR digital video data, non-IR digital video data, analog video data, still images, light properties or other data generated by one or more sensors. In still other examples, the sensor data 248 may include IR camera still images, IR camera video images, digital video output, or other image data. For example, the sensor data 248 may include Moving Pictures Experts Group (MPEG) video output.

Freshness indicator 230 also obtains product data 232 from database 218. Product data 232 is any data pertaining to the product in general, rather than data about a specific set of the product. Product data may include general characteristics of the product, expected origins of the product, size range for the product, weight range for the product, crop progress expectations for the product within ideal conditions, geolocations associated with the product, such as where the product is grown or supplied, quality/condition parameters for the product, and any other criteria or information defined by regulatory authorities and/or industry standards. Product data 232 may be integrated as part of product inspector 208, in some examples, or obtained by product inspector 208 in other examples, for use in generating inspection data 242. Freshness indicator 230 obtains inspection data 242 from product inspector 208 in some examples, for use in determining freshness indicator values for inspected products. In other examples, product inspector 208 transmits generated inspection data 242 to freshness indicator.

The freshness indicator 230 uses one or more of pre-harvest data 234, harvest data 236, supply chain data 238, environmental data 240, and inspection data 242 to calculate freshness indicator values 254. Freshness indicator 230 may include a customized algorithm, a set of rules, and/or a set of criteria and parameters to determine the freshness indicator values based on the data obtained at various intervals throughout a product life cycle. The freshness indicator values 254 may be specific to a particular piece of product or a set of products at a given time or stage in the product life cycle. For example, a first freshness indicator value may be calculated based on pre-harvest data 234 and harvest data 236 at the stage where the product arrives at a packing facility post-harvest. A second freshness indicator value may be calculated for the same product based on the first freshness value calculated and supply chain data 238 at the stage where the product arrives at a distribution center, for example. Another freshness indicator value may be calculated for the same product based on the previous assigned freshness value calculated and inspection data 242, for example. The order and process described herein is not meant to imply a singular process flow, but rather is provided for illustrative purposes only. A freshness indicator value may be calculated based on available data at any point in the products life cycle, from pre-harvest to a final touch point at a market display, using the system described herein.

Freshness indicator 230 may be used to generate a freshness indicator value for a sample selection of product from a set of products, or to individual products in a batch or set or products. In some examples, freshness indicator 230 may be specific to a particular store, group of stores, region, or other location, to provide customized freshness indicator values in accordance with a particular store specification or regional specification. It should be appreciated by one of skill in the art that freshness indicator 230 may be customized in a variety of ways to address the specifications of specific stores, institutions, inspections, personnel, agencies, management, or the like.

Freshness indicator 230 may also be used to determine whether a product is acceptable. Any attribute of a product that may be sensed or calculated from a sensor or measured is thus an attribute that may be used as a basis or parameter of the algorithm used to determine freshness indicator values 254. By way of example, a computing device implementing a freshness indicator component with sensor data obtained from a temperature probe may use temperature in the algorithm. As another example, freshness indicator 230 obtaining sensor data from an image capture device may analyze image data to determine factors for use in the algorithm to calculate the freshness indicator value. Freshness indicator 230 may also obtain and/or receive inspection data 242 from product inspector 208, which determines whether the product has any defects, such as a puncture for example, which may be used as a factor in the algorithm that calculates the freshness indicator values.

The product inspector and/or the freshness indicator may generate an alert based on any number of factors detected and/or identified from the obtained data. For example, an alert may be generated during inspection of produce upon the determination that a foreign substance is present on the produce. The presence of a foreign substance may be determined by inspecting produce and determining the presence of a substance on the surface of the produce that is not related to the produce based on the produce data retrieved. For example, based on identifying characteristics, such as color or texture, the foreign substance may be determined to be mold. The alert may identify one or more users associated with the inspection system to perform a secondary inspection and/or remove produce from a set of produces being inspected, in some examples.

Shelf life predictor 244 uses freshness indicator values 254 generated by freshness indicator 230 to calculate shelf life predictions 246 for a product, or a set of products, during various stages of the products life cycle. Shelf life predictor 244 may also use one or more of product data 232 and environmental data 240, in combination with the generated freshness indicator values, to calculate the shelf life predictions 246. For example, shelf life predictor 244 may obtain a first freshness indicator value from freshness indicator 230 at a stage where a product arrives at a distribution center, and may calculate the current shelf life prediction based on the first calculated freshness indicator value at that stage. Upon obtaining an updated freshness indicator value for the same product at a later stage, shelf life predictor 244 may calculate an updated shelf life prediction based on the earlier shelf life prediction and the updated freshness indicator value. In addition, shelf life predictor 244 may obtain environmental data that is used to adjust the calculation of shelf life predictions 246. For example, shelf life predictor 244 may obtain a freshness indicator value for a product as it arrives at a market, in addition to environmental data for that particular market that indicates environmental conditions that will impact the shelf life of the product, and may calculate an updated shelf life prediction for that product based on both the freshness indicator value and the obtained environmental data. It should be appreciated that the freshness indicator values may be generated multiple times, iteratively throughout the life cycle or product stages through a supply chain, and the shelf life predictions may also be generated multiple times or updated iteratively depending on the circumstances and data obtained. For example, a piece of produce that must undergo a long transportation process may have its freshness indicator value recomputed several times during transport, where a piece of produce grown locally may only need to have the freshness indicator generated once or a twice before it reaches market.

Other criteria may be used to generate freshness indicator values and shelf life predictions and may include inspection data such as visible defects, unusual markings, temperature, indications of damage such as tears or punctures, smell, color consistency, packaging imperfections, and presence of other substances such as mold. These examples are non-limiting. Any attribute of a product that may be detected by a sensor, directly or indirectly, or calculated based on sensor data, may be a basis for calculation of a products freshness, and in turn used to calculate a shelf life prediction. Different criteria may be used for different products, and different criteria may be used for the same product type based on variances such as product origin, for example. Criteria may also be combined in making determinations or generating freshness indicator values and calculating shelf life predictions.

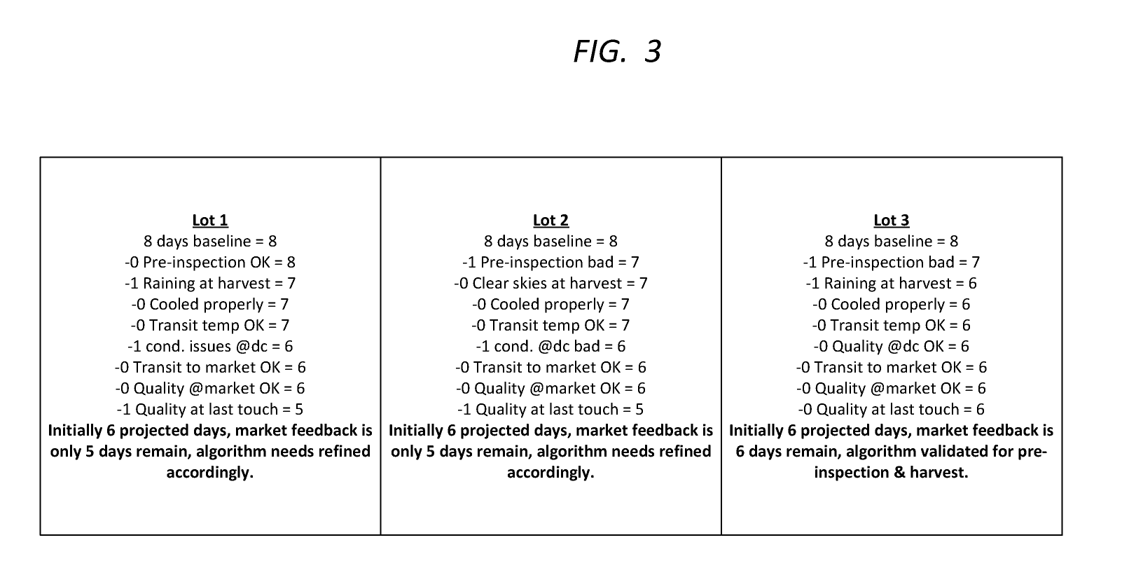

FIG. 3 is an exemplary chart of one embodiment of an output of shelf life predictions based on calculated freshness indicator values and a feedback loop that refines the shelf life prediction model. The freshness component will take input from data sources, such as information sources 224 in FIG. 2, via one or more APIs and assign each data input a weight when calculating against a baseline “best case” scenario for a given produce. The baseline “best case” or “ideal” scenario for a given product may be a base model of ideal growth, harvest, transport, packing, storage, and inspection conditions, with an associated optimal result, such as optimal freshness values and/or optimal shelf life duration. Freshness indicator 230 may use this baseline for calculating against actual data points received from information sources 224 for the product being evaluated to determine the freshness indicator value for that product, which in turn is used to calculate the shelf life prediction for that product.

The weighting may be dynamic and may be based upon machine learning on a feedback loop. In the example of FIG. 3, a baseline “rule of thumb” may be obtained from industry sources on how particular products are impacted by a variety of factors and used to generate baseline models for each particular product. An initial calculation (before machine learning) of days of life at market (shelf life) may be made for a product based on the corresponding baseline model.

In the example of FIG. 3, actual data points for three lots of produce, such as strawberries for example, are input and calculated against the baseline model to generate freshness indicator values for each individual lot. The freshness indicator values for each lot are then used by shelf life predictor 244 to calculate a shelf life prediction for each lot. The system receives market feedback on the actual shelf life at market for each lot, which is used by machine learning component 258 to refine freshness model 266 of freshness indicator 230 and by machine learning component 264 to refine shelf life predictor 244.

As seen in the sample data sets, Lot-1, Lot-2, and Lot-3 all have the same baseline shelf life projection (8 days), as each of these sample lots are for the same type or produce in this example. The data inputs for Lot-1 include a null input at a pre-inspection stage, which may be a pre-harvest data point for example. The null input may indicate that pre-harvest data is in alignment with ideal pre-harvest conditions, for example, which would not affect the baseline projection, and accordingly the output of 8 days would remain consistent at that data point. A harvest data point input indicates there was rain present during harvest of Lot-1, and the system weights this data point at a −1, which adjust the baseline projection down to 7 days. A next data point may be from post-harvest data, such as data obtained during the packing/cooling facility stage, which may also be considered supply chain data in some examples. The data input for Lot-1 indicates this selection of produce was cooled properly, which does not affect the system weighting for that data point. Likewise, the subsequent data point from transportation data, which may also be considered supply chain data, indicates that temperature of the produce was properly maintained during transport, and the weighting is not affected here either. A condition data input, which may be considered inspection data, indicates a −1 score, which may be due to a detected or identified characteristic during inspection. Here, the −1-weighting applied adjusts the projection to 6 days for shelf life of this particular lot of produce. The transportation data, or supply chain data, obtained for the transport stage from a distribution center to market, and the inspection data obtained at an arrival stage of the product at market, both indicate conditions within parameters, or no weighting applied for Lot-1. Here, the predicted shelf life is calculated at 6 days, based on the factors considered and data obtained, and at market arrival the 6-day shelf life prediction is output by the system. At a final touch point at market, which may be a removal from shelf due to end of shelf life in some examples or an additional inspection at market in other examples, a −1 weighting is applied, which may indicate a detected characteristic for Lot-1 that impacts predicted shelf life and updates the actual shelf life for Lot-1 to 5 days. This market feedback is used as feedback to the system as actual shelf life at market being 5 days compared against the predicted 6 days, and is used to refine the system algorithms for future predictions.

The additional data sets for Lot-2 and Lot-3 illustrate different data points or data inputs at various stages of the product life cycle which impact the calculated freshness indicator values and the shelf life prediction accordingly. As with Lot-1, the market feedback continues to refine the system and is used as a feedback loop for the machine learning components of the system.

With multiple data points, the calculation/weighting can be triangulated and improved with additional feedback from the system. In addition, the feedback may be used to validate portions of the calculations while refining other portions of the calculations. For example, as shown in the data set of Lot-3, the algorithm is validated for pre-inspection (or pre-harvest) and harvest variable calculations used for Lot-1 and Lot-2, indicating that the weighting in Lot-1 and Lot-2 for distribution center (DC) condition/quality issues may be further refined. The algorithm may therefore increase the weighting for that input in the final calculation, improving the accuracy for the next lots of the same produce.

FIG. 4 is an exemplary block diagram illustrating a set of sensors for gathering environmental and product data. The set of sensors 400 is a set of one or more sensors. In some cases, set of sensors 400 may be part of computing device 202. In other cases, set of sensors 400 may be communicatively coupled to computing device 202. The set of sensors 400 may be used to detect or obtain data associated with products and/or the product environments. The set of sensors 400 in some examples includes one or more thermometer(s) 402, one or more barometer(s) 404, one or more hygrometer(s) 406, one or more change of state sensor(s) 408, a spectrometer(s) 409, and/or one or more image capture device(s) 410. In some examples, the image capture device(s) 410 includes at least one IR camera 412. The sensors are used to generate or obtain sensor data, including product data and environmental data related to products. In some cases, sensors may work together or with other devices.

For instance, a GPS system may be used to identify the location of a thermometer or temperature sensor associated with a product, which may aid the freshness indicator system in identifying additional environmental data corresponding to the location or route of travel for the product. For example, a particular environmental condition might be present in a certain geographic area, and the freshness indicator system may be configured to analyze and factor in the environmental conditions with other obtained data corresponding to the product when calculating freshness indicator values. The sensor data generated by set of sensors 400 may be obtained or acquired by the product inspector 208, freshness indicator 230, and/or shelf life predictor 244 in FIG. 2, for example. The sensor data may then be used to generate other data, such as pre-harvest data, harvest data, supply chain data, environmental data, inspection data, and the like, which is used by the system to calculate freshness indicator values and predict shelf life of a product.

A change of state sensor is a non-electrical, non-reversing sensor that monitors a change of state of the produce, such as a change in temperature, a change in a state of matter, a change in a moisture level or texture, etc. A change of state of matter includes a change from ice to water, a change from water to steam, etc. A spectrometer is used to determine information about an object or substance through analysis of its light properties.

Sensor data from the thermometer(s) 402, barometer(s) 404, hygrometer(s) 406, and/or change of state sensor(s) 408, spectrometer(s) 409, may be stored and/or transmitted in concert with image capture data generated by image capture device(s) 410 for evaluation of a product or product environment. For example, hygrometer data indicating moisture levels of produce may be sent with IR image data to product inspector component for analysis during inspection. The product inspector component may analyze the moisture data and IR data to determine whether a produce item is moist or drying out, for example.

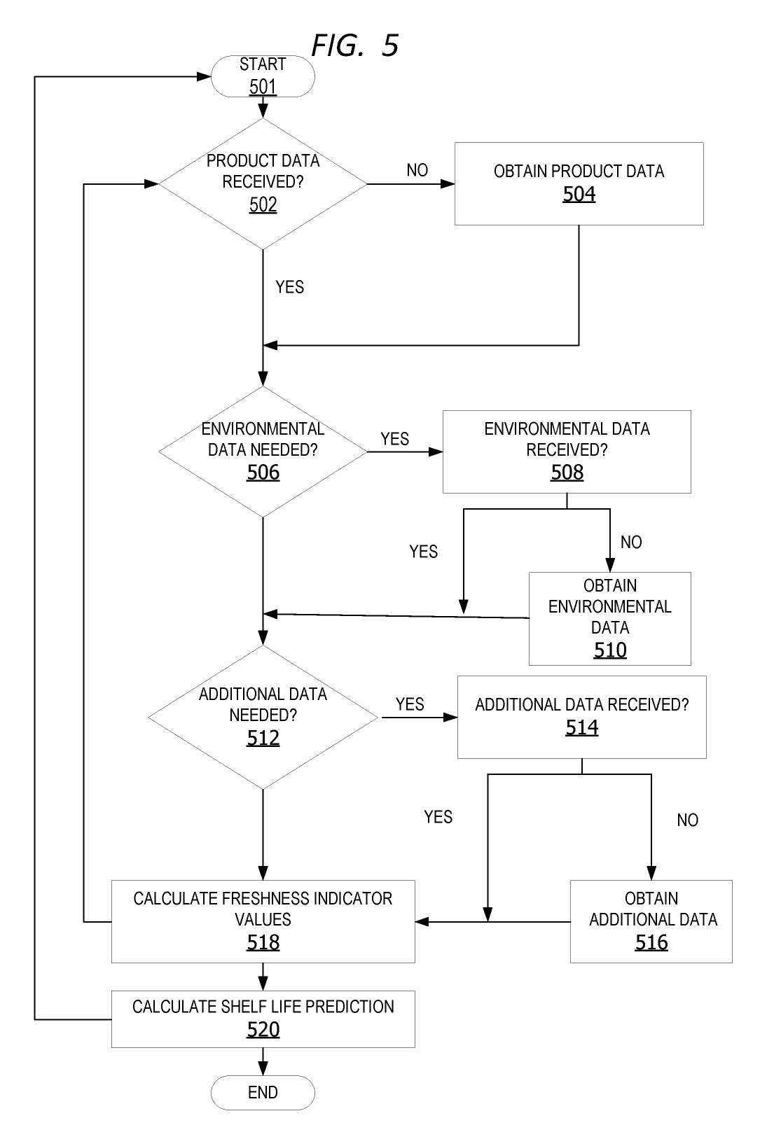

FIG. 5 is an exemplary flow chart of a process for determining freshness and shelf life of a product. The process shown in FIG. 5 may be performed by a shelf life predictor and a freshness indicator component executing on a computing device, such as, but not limited to, freshness indicator 230 and shelf life predictor 244 in FIG. 2. One or more computer-readable storage media storing computer-readable instructions may execute to cause at least one processor to implement the operations illustrated in FIG. 5.

The process beings at operation 501. The process may be triggered by any number of events such as receipt of product, scheduled intervals, or any other suitable factor. In some cases, the process may be manually triggered, for example, at a field inspection of produce, such as during a pre-harvest stage for example. In other cases, the process may be automated such as upon scanning of a received package from a supplier. In still other cases, it may be based upon periodic updates, which may happen when a package is in transit. A determination is made as to whether product data has been received from one or more sources at operation 502. Product data, in some examples, include one or more stored characteristics of the product type, pre-harvest product-specific data, harvest product-specific data, supply chain product-specific data, transportation product-specific data, inspection product-specific data, and the like. In some aspects, the sources of product data may be external to the computing device, such as a remote server or cloud infrastructure. In other aspects, the sources may be local to the device or added to the device using a USB drive or similar device. If the product data has not been received, product data is obtained at operation 504 by a freshness indicator component, such as freshness indicator 230 in FIG. 2 for example, or another similar component. Product data may be obtained from a number of different data sources, such as information sources 224 and/or set of sensors 220 in FIG. 2, for example.

At operation 506, a determination is made as to whether environmental data is needed from one or more sources. This determination may be based on the product stage at which the calculations are being performed. For example, during transportation, environmental data may be needed. However, upon reaching the store, environmental data may not be a factor, yet inspection data may be desired. Environmental data in some examples include information from one or more sensors and/or information from public sources, such as weather services or government agencies. In some aspects, the sources of environmental data may be external to the computing device, such as networked servers or drives. As with product data, environmental data may be obtained from web servers, web services, internet servers, remote databases, and the like. In other aspects, the environmental data sources may be local to the device or added to the device using a USB drive or similar device. If the environmental data is desired then at operation 508, a determination is made as to whether it has been received. If the environmental data has not been received, environmental data is obtained at operation 510 by a freshness component, such as freshness indicator 230 in FIG. 2 for example, or another similar component. In one example, environmental data may include harvest product-specific data associated with the product and obtained via one or more sensors at a growing location and/or one or more grower technology APIs.

A determination is made as to whether additional data is needed from one or more sources at operation 512. Additional data in some examples include data from third party applications or from transportation databases. In other cases, additional data may be thresholds or the like associated with products or other aspects of the process. In some aspects, the sources of additional data may be external to the computing device, such as networked servers or drives. As with product data, additional data may be from web servers, web services, internet servers, remote databases, and the like. In other aspects, the additional data sources may be local to the device or added to the device using a USB drive or similar device. If the additional data is desired, then at operation 514, a determination is made as to whether it has been received. If the additional data has not been received, additional data is obtained at operation 516 by a freshness component, such as freshness indicator 230 in FIG. 2 for example, or another similar component. The additional data, if obtained, and the environmental data, if obtained, is used together with the product data obtained to calculate freshness indicator values at operation 518 for the product.

At operation 520, data shelf life prediction is calculated based on the calculated freshness indicator values, and the process iteratively repeats for a next stage of the product life cycle, or terminates thereafter. It should be appreciated that only a subset of the listed data may be needed to generate a freshness score, or freshness indicator value, in some instances. Freshness scores may be specific to a particular produce or type of produce. In one example, the freshness score is based on comparing the pre-harvest product-specific data and the harvest product-specific data with at least one product-specific threshold associated with the product.

The process of generating freshness indicator values may be repeated as necessary. The generated freshness indicator values are then used to calculate shelf life predications, which may also be updated as new freshness indicator values are calculated and provided.

While the operations illustrated in FIG. 5 are performed by a computing device, aspects of the disclosure contemplate performance of the operations by other entities or multiple entities working in concert or independently. For example, a cloud service may perform one or more of the operations.

FIG. 6 is an exemplary illustration of a device obtaining information about a product. Such information retrieval may be used by a market associate prior to placing products on display, or while products are on display at market, for example. In other examples, the exemplary information retrieval may be performed as part of an inspection process at one or more stages of a product life cycle.

Device 601 is an illustrative example of a computing device, such as computing device 202 in FIG. 2, for example. Device 601 comprises image sensor 602 and touchscreen 603. Touchscreen 603 may be an integrated touch sensing element and display element, for example. Additionally, device 601 may comprise other sensors 604. Device 601 may use image sensor 602 to obtain sensor data regarding produce 610. Sensor data may be analyzed by a shelf life predictor, such as shelf life predictor 244 in FIG. 2, implemented on device 601. The shelf life predictor application may output shelf life prediction 606 to a display of device 601, in one example. In other example, shelf life predictor may be implemented remote from device 601, and device 601 may communicate with shelf life predictor at a back-end server to obtain shelf life prediction 606 for produce 610.

In some examples, additional produce metrics 607 may be displayed for produce 610. Produce metrics 607 may be generated by a freshness indicator component implemented on device 601, such as freshness indicator 230 in FIG. 2, or by some other component using the freshness indicator values calculated by a freshness component for produce 610. In some instances, the shelf life predictor and/or freshness component may reside on a remote computing device or remote server such as external server 252 in FIG. 2. In some instances, shelf life prediction 606 and produce metrics 607 may be presented to a user via touchscreen 603. In other instances, shelf life prediction 606 and produce metrics 607 may be transmitted for further analysis, such as to external server 252 in FIG. 2. In addition to shelf life prediction 606 and produce metrics 607, any data associated with the produce may be retrieved. Although shown with regards to a device with a touchscreen, other implementations are also possible. Additionally, discrete aspects may be implemented in other methods. For example, shelf life prediction 606 may be displayed on a smart display or user interface adjacent to a product display where product 610 is placed, which a consumer may access to obtain product information. Alternatively, a display may use a dynamic QR code associated with produce 610 which may be scanned by a customer to obtain product-specific data for produce 610.

For example, a dynamic QR code may be updated with current product information corresponding to the products currently on display adjacent to the QR code. Scanning the QR code may present a consumer with product information about the current product on display, that is, the selection or lot of produce most recently placed on display with that code for example. In this illustrative example, a lot of apples may be on display and the dynamic QR code may provide product information such as the geographic location of origin for the lot of apples, the predicted shelf life or a freshness indicator for the lot of apples, the number of days the lot of apples have been at market, grower information for the lot of apples (supplier information), growth data for the lot of apples (such as organic or sustainable farming practices for example), and any other desirable product information. As a new lot of apples is placed on display, the dynamic QR code may be updated with product-specific information obtained from the freshness component system for that new lot. A consumer may use device 601 to scan a dynamic QR code in this example to obtain a shelf life prediction 606 and produce metrics 607.

Device 601 may also generate an alert 608 based on obtained data for produce 610. In some examples, where a market associate uses device 601 to obtain data on product 610, the inspection system or freshness component system may generate alert 608 to notify a market associate of additional inspection needed, criteria to look for and confirm/deny related to a detected characteristic during inspection or a predicted characteristic based on product data obtained, and the like. In some examples, a market associated may use device 601 as part of an inspection system to obtain image data or other sensor data on produce 610 in order to generate inspection data.

### Additional Examples

At least a portion of the functionality of the various elements in FIG. 2, FIG. 4, and FIG. 6 may be performed by other elements in FIG. 2, FIG. 4, and FIG. 6, or an entity (e.g., processor, web service, server, application program, computing device, etc.) not shown in FIG. 2, FIG. 4, or FIG. 6.

In some examples, the operations illustrated in FIG. 1 and FIG. 5, may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements. Operations may be performed on a single device, or multiple devices communicatively coupled together. Aspects of the disclosure may be performed at one location or different locations communicatively coupled together. Additionally, results of some operations may be sent as copies to different devices. For instance, a network server may be used to generate a freshness indicator or shelf life. The generated freshness indicator or shelf life may then be sent to a plurality of computing devices. Additionally, aspects of the disclosure such as notifications and alerts may be sent to a single device, multiple devices or used by other applications or programs.

Product data, environmental data, or any other data, may be obtained from a variety of sources, such as, but without limitation, historical data collected by companies, industries, trade groups, or other such organizations. Data associated with a product may be manually input by users or those with knowledge of the product in some examples. Information gathered by sensors may be used not only to predict shelf life but also to determine whether a produce is acceptable for market. Other determinations may include expiration date, use-by dates, sell-by dates etc. For instance, bananas stored in special rooms may be treated with temperature and/or gas to ripen or delay ripening, which may adjust or otherwise affect shelf life predictions.

Communication and storage may be accomplished by a variety of devices and through a variety of means. Communication may be over wireless networks such as BLUETOOTH or Wi-Fi or over wired networks such as ethernet and phone lines. Communication may be direct through devices, through corporate intranets, the internet, cloud based services or the like. Similarly, storage of data and components may be on computing devices, local servers, network servers, remote servers, cloud applications and devices, mobile devices, kiosks etc.

While the aspects of the disclosure have been described in terms of various examples with their associated operations, a person skilled in the art would appreciate that a combination of operations from any number of different examples is also within scope of the aspects of the disclosure.

Alternatively, or in addition to the other examples described herein, examples include any combination of the following:
wherein the pre-harvest product-specific data comprises at least one of growth rate data, field data, crop data, geolocation data, quality data, environmental data, or condition data;
generate a shelf life prediction for the product based on the first set of freshness indicator values;
wherein the processor is further configured to execute the computer-executable instructions for the freshness indicator to determine at least one of the following based on the generated shelf life prediction: priority of placement of the product in inventory, selection of a distribution center for the product, transaction value of the product, inspection criteria for the product, and quality metrics associated with one or more suppliers of the product;
obtain inspection data for the product from an inspection system;
generate a second set of freshness indicator values for the product based on the inspection data and the first set of freshness indicator values;
generate an updated shelf life prediction for the product based on the second set of freshness indicator values and the first set of freshness indicator values;
obtain supply chain product-specific data associated with the product and corresponding to a time period between a harvest stage and an inspection of the product at a final touch point;
obtain additional inspection data associated with the final touch point;
generate a third set of freshness indicator values for the product based on the obtained supply chain product-specific data, the additional inspection data, and the second set of freshness indicator values;
generate an updated shelf life prediction for the product based on the third set of freshness indicator value and the second set of freshness indicator values;

The term “Wi-Fi” as used herein refers, in some examples, to a wireless local area network using high frequency radio signals for the transmission of data. The term “BLUETOOTH” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

### Example Operating Environment

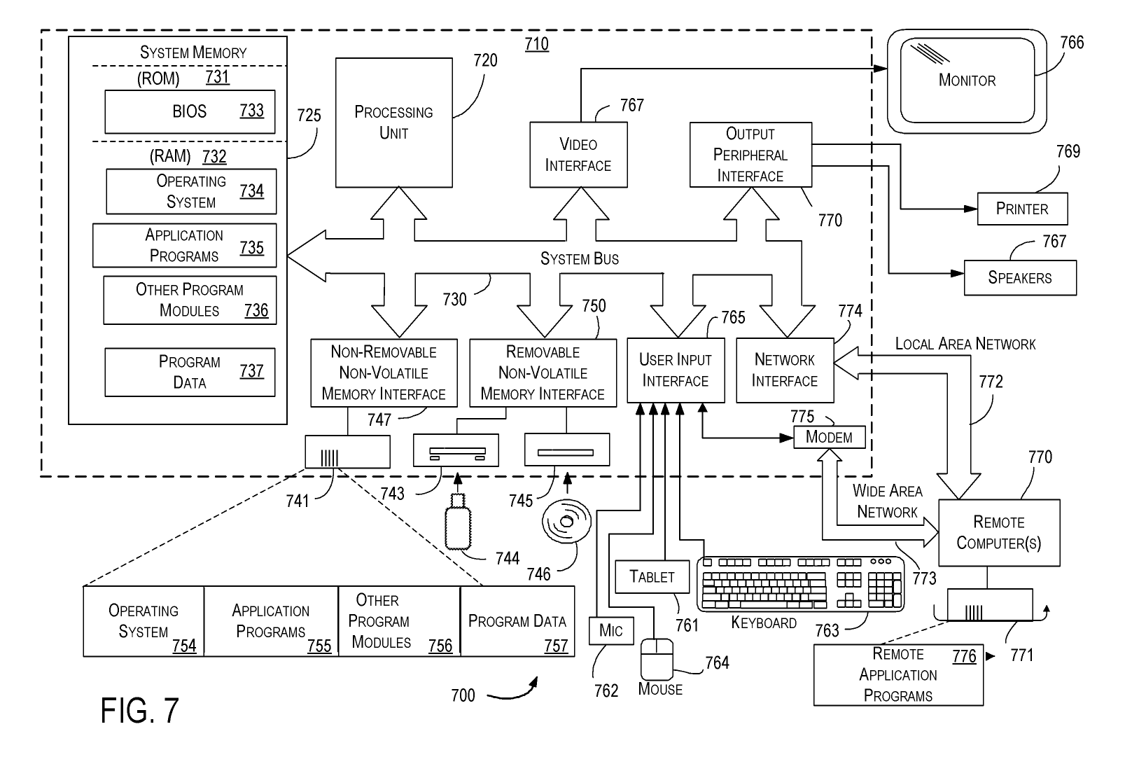

FIG. 7 is a block diagram illustrating an example operating environment 700 for a computing device (e.g., computing device 202 in FIG. 2). The computing system environment 700 is only one example of a suitable computing environment and is not intended to suggest any limitation as to the scope of use or functionality of the disclosure. Neither should the computing environment 700 be interpreted as having any dependency or requirement relating to any one or combination of components illustrated in the example operating environment 700.

The disclosure is operational with numerous other general purpose or special purpose computing system environments or configurations. Examples of well-known computing systems, environments, and/or configurations that may be suitable for use with the disclosure include, but are not limited to: personal computers, desktop computers, laptop computers, tablet devices, netbooks, handheld devices, mobile telephones, wearables, gaming devices, portable media players, server computers, kiosks, set top boxes, tabletop devices, multiprocessor systems, microprocessor-based systems, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and so forth, which perform particular tasks or implement particular abstract data types. The disclosure may also be practiced in distributed computing environments where tasks are performed by remote processing devices that are linked through a communications network. In a distributed computing environment, program modules may be located in local and/or remote computer storage media including memory storage devices and/or computer storage devices. As used herein, computer storage devices refer to hardware devices.

With reference to FIG. 7, an example system for implementing various aspects of the disclosure may include a general-purpose computing device in the form of a computer 710. Components of the computer 710 may include, but are not limited to, a processing unit 720, a system memory 725, and a system bus 730 that couples various system components including the system memory to the processing unit 720. The system bus 730 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 710 typically includes a variety of computer-readable media. Computer-readable media may be any available media that may be accessed by the computer 710 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or the like. Read only memory (ROM) 731 and random-access memory (RAM) 732 are examples of computer storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information, and which may be accessed by the computer 710. Computer storage media does not, however, include propagated signals. Rather, computer storage media excludes propagated signals. Any such computer storage media may be part of computer 710.

Communication media typically embodies computer-readable instructions, data structures, program modules or the like in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 725 includes computer storage media in the form of volatile and/or nonvolatile memory such as ROM 731 and RAM 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs, such as application programs 735 (e.g., appliance management environment), other program modules 736 and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a universal serial bus (USB) port 743 that provides for reads from or writes to a removable, nonvolatile memory 744, and an optical disk drive 745 that reads from or writes to a removable, nonvolatile optical disk 746 such as a CD ROM or other optical media. Other removable/non-removable, volatile/nonvolatile computer storage media that may be used in the example operating environment include, but are not limited to, magnetic tape cassettes, flash memory cards, digital versatile disks, digital video tape, solid state RAM, solid state ROM, and the like. The hard disk drive 741 is typically connected to the system bus 730 through a non-removable memory interface such as interface 747, and USB port 743 and optical disk drive 745 are typically connected to the system bus 730 by a removable memory interface, such as interface 750.

The drives and their associated computer storage media, described above and illustrated in FIG. 7, provide storage of computer-readable instructions, data structures, program modules and other data for the computer 710. In FIG. 7, for example, hard disk drive 741 is illustrated as storing operating system 754, application programs 755 (e.g., an appliance management environment), other program modules 756 and program data 757. Note that these components may either be the same as or different from operating system 734, application programs 735, other program modules 736, and program data 737. Operating system 754, application programs 755, other program modules 756, and program data 757 are given different numbers herein to illustrate that, at a minimum, they are different copies.

A user may enter commands and information into the computer 710 through input devices such as a tablet, or electronic digitizer, 761, a microphone 762, a keyboard 763 and pointing device 764, commonly referred to as mouse, trackball or touch pad. Other input devices not shown in FIG. 7 may include a joystick, game pad, digital camera, scanner, or the like. These and other input devices are often connected to the processing unit 720 through a user input interface 765 that is coupled to the system bus, but may be connected by other interface and bus structures, such as a parallel port, game port or a universal serial bus (USB). A monitor 766 or other type of display device is also connected to the system bus 730 via an interface, such as a video interface 767. The monitor 766 may also be integrated with a touchscreen panel or the like. Note that the monitor and/or touchscreen panel may be physically coupled to a housing in which the computing device 710 is incorporated, such as in a tablet device. In addition, computers such as the computing device 710 may also include other peripheral output devices such as speakers 767 and printer 769, which may be connected through an output peripheral interface 770 or the like.

The computer 710 may operate in a networked environment using logical connections to one or more remote computers, such as a remote computer 770. The remote computer 770 may be a personal computer, a server, a router, a network PC, a peer device or other common network node, and typically includes many or all of the elements described above relative to the computer 710, although only a memory storage device 771 has been illustrated in FIG. 7. The logical connections depicted in FIG. 7 include one or more local area networks (LAN) 772 and one or more wide area networks (WAN) 773, but may also include other networks. Such networking environments are commonplace in offices, enterprise-wide computer networks, intranets and the Internet.

When used in a LAN networking environment, the computer 710 is connected to the LAN 772 through a network interface controller or adapter 774. When used in a WAN networking environment, the computer 710 typically includes a modem 775 or other means for establishing communications over the WAN 773, such as the Internet. The modem 775, which may be internal or external, may be connected to the system bus 730 via the user input interface 760 or other appropriate mechanism. A wireless networking component such as comprising an interface and antenna may be coupled through a suitable device such as an access point or peer computer to a WAN or LAN. In a networked environment, program modules depicted relative to the computer 710, or portions thereof, may be stored in the remote memory storage device. By way of example, and not limitation, FIG. 7 illustrates remote application programs 775 as residing on memory device 771. It may be appreciated that the network connections shown are exemplary and other means of establishing a communication link between the computers may be used.

The examples illustrated and described herein as well as examples not specifically described herein but within the scope of aspects of the disclosure constitute an example appliance management environment. For example, the elements illustrated in FIG. 1, FIG. 2, FIG. 4, FIG. 6 and FIG. 7, such as when encoded to perform the operations illustrated in FIG. 5, constitute exemplary means for obtaining data pertaining to a product, exemplary means for calculating a set of freshness indicator values for a product, and exemplary means for calculating shelf life predictions for a product.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure. Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A computing system for dynamically generating product freshness indicators, the computing system comprising:
a memory device storing computer-executable instructions for a freshness indicator; and
a processor communicatively coupled to the memory device and configured to execute the computer-executable instructions for the freshness indicator to:
obtain pre-harvest product-specific data associated with a product, the pre-harvest data comprising at least one of growth rate data, field data, crop data, geolocation data, quality data, environmental data, or condition data;
obtain harvest product-specific data associated with the product;
obtain sensor data from one or more sensors associated with the product post-harvest;
calculate a first set freshness indicator values for the product based on the obtained pre-harvest product-specific data, the obtained harvest product-specific data, and the obtained sensor data;
generate a shelf life prediction for the product based on the first set of freshness indicator values;
obtain inspection data for the product from an inspection system; and
generate a second set of freshness indicator values for the product based on the inspection data and the first set of freshness indicator values.

2-3. (canceled)

4. The computing system of claim 1, wherein the processor is further configured to execute the computer-executable instructions for the freshness indicator to determine at least one of the following based on the generated shelf life prediction: priority of placement of the product in inventory, selection of a distribution center for the product, transaction value of the product, inspection criteria for the product, and quality metrics associated with one or more suppliers of the product.

5. (canceled)

6. The computing system of claim 1, wherein the processor is further configured to execute the computer-executable instructions for the freshness indicator to:
generate an updated shelf life prediction for the product based on the second set of freshness indicator values and the first set of freshness indicator values.

7. The computing system of claim 1, wherein the processor is further configured to execute the computer-executable instructions to:
obtain supply chain product-specific data associated with the product and corresponding to a time period between a harvest stage and an inspection of the product at a final touch point;
obtain additional inspection data associated with the final touch point; and
generate a third set of freshness indicator values for the product based on the obtained supply chain product-specific data, the additional inspection data, and the second set of freshness indicator values.

8. The computing system of claim 7, wherein the processor is further configured to execute the computer-executable instructions to:
generate an updated shelf life prediction for the product based on the third set of freshness indicator value and the second set of freshness indicator values.

9. A computer-implemented method for generating product freshness indicators, the computer-implemented method comprising:
obtaining pre-harvest product-specific data associated with a product, the pre-harvest data comprising at least one of growth rate data, field data, crop data, geolocation data, quality data, environmental data, or condition data;
obtaining harvest product-specific data associated with the product;
obtaining sensor data from one or more sensors associated with the product post-harvest;
calculating a first set of freshness indicator values for the product based on the obtained pre-harvest product-specific data, the obtained harvest product-specific data, and the obtained sensor data;
generating a shelf life prediction for the product based on the first set of freshness indicator values;
obtaining inspection data for the product from an inspection system; and
generating a second set of freshness indicator values for the product based on the inspection data and the first set of freshness indicator values.

10-11. (canceled)

12. The computer-implemented method of claim 9, wherein the generated shelf life prediction is used to determine at least one of: priority of placement of the product in inventory, selection of a distribution center for the product, transaction value of the product, inspection criteria for the product, and quality metrics associated with one or more suppliers of the product.

13. (canceled)

14. The computer-implemented method of claim 9, further comprising:
obtaining supply chain product-specific data associated with the product and corresponding to a time period between a harvest stage and an inspection of the product at a final touch point;
obtaining additional inspection data associated with the final touch point; and
generating a third set of freshness indicator values for the product based on the obtained supply chain product-specific data, the additional inspection data, and the second set of freshness indicator values.

15. One or more computer storage media having computer-executable instructions stored thereon for generating product freshness indicators, that upon execution by a processor, causes the processor to:
obtain pre-harvest product-specific data associated with a product, the pre-harvest data comprising at least one of growth rate data, field data, crop data, geolocation data, quality data, environmental data, or condition data;
obtain harvest product-specific data associated with the product;
obtain sensor data from one or more sensors associated with the product post-harvest; and
generate a first set of freshness indicator values for the product based on the obtained pre-harvest product-specific data, the obtained harvest product-specific data, and the obtained sensor data;
generate a shelf life prediction for the product based on the first set of freshness indicator values;
obtain inspection data for the product from an inspection system; and
generate a second set of freshness indicator values for the product based on the inspection data and the first set of freshness indicator values.

16-18. (canceled)

19. The one or more computer storage devices of claim 15, that upon execution by the processor, causes the processor to:
obtain supply chain product-specific data associated with the product and corresponding to a time period between a harvest stage and an inspection of the product at a final touch point;
obtain additional inspection data associated with the final touch point; and
generate a third set of freshness indicator values for the product based on the obtained supply chain product-specific data, the additional inspection data, and the second set of freshness indicator values.

20. The computing system of claim 19, wherein the processor is further configured to execute the computer-executable instructions to
generate an updated shelf life prediction for the product based on the third set of freshness indicator values and the second set of freshness indicator values.
